(19) United States
(12) Patent Application Publication
(10) Pub. No.: US 2024/0341303 A1
(43) Pub. Date: Oct. 17, 2024

(54) PLANT SURFACE PROTECTIVE COMPOSITION FOR DELAYING BUD-BREAK, METHODS OF USE AND MANUFACTURE

(71) Applicant: FROSTDEFENSE ENVIROTECH, INC., Champaign, IL (US)

(72) Inventors: Manfredo Seufferheld, Champaign, IL (US); Gabriel Burks, Champaign, IL (US)

(21) Appl. No.: 18/294,225

(22) PCT Filed: Aug. 5, 2022
(86) PCT No.: PCT/US2022/074567

§ 371 Date: Feb. 1, 2024

Related U.S. Application Data
(60) Provisional application No. 63/230,311, filed on Aug. 6, 2021.

(51) Int. Cl. A01N 25/10; A01N 3/00; A01N 25/24; A01N 43/16

(52) U.S. Cl. CPC A01N 25/10; A01N 3/00; A01N 25/24; A01N 43/16

(57) ABSTRACT

Provided herein are compositions and methods useful for increasing cold hardiness and/or preventing bud-break in a crop. The compositions and methods provide a composition that forms a protective capsule around at least a portion of a crop that delays bud break and increases plant cold-hardiness by at least about 0.5° C., and up to about 10° C. or more.

### CROSS REFERENCE TO RELATED APPLICATIONS

This application claims priority under 35 U.S.C. § 119 to provisional patent application U.S. Ser. No. 63/230,311, filed Aug. 6, 2021. The provisional patent application is herein incorporated by reference in its entirety, including without limitation, the specification, claims, and abstract, as well as any figures, tables, appendices, or drawings thereof.

### STATEMENT REGARDING FEDERALLY SPONSORED RESEARCH OR DEVELOPMENT

This invention was made with government support under Grant Number 2125182 awarded by the National Science Foundation. The government has certain rights in the invention.

### TECHNICAL FIELD

The present disclosure relates generally to formulations and methods useful for increasing cold hardiness and/or preventing bud-break for crops in an agricultural setting, for example a vineyard, crop production field, or fruit orchard.

### BACKGROUND

Frost damage, for example in early spring, is a major reason why wine growers lose more than $10 billion a year. Phenological shifts and increasing weather volatility, likely associated with climate change, exacerbates the problem. Frost causes more economic losses to agriculture than any other climate related hazard. In the US alone, annual economic loss from frost in European grape cultivars (common in the US) is estimated at $4,500 per Hectare according to grape data provided by growers. A typical 50-Ha farm with half of its area subjected to frost damage could accrue over $100,000 in losses from a single frost event. Existing responses such as heaters, wind machines, sprinklers, and other solutions are expensive and/or inadequate.

Currently there is a need for methods and agents that are useful for increasing the cold hardiness of plants and/or delaying plant bud break. There is also a need for agents that allow for application prior to bud break that provide protection through a time period of high frost potential. Such methods and agents could reduce crop losses world wide. The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

### SUMMARY

The disclosure herein provides a non-hormonal solution for crops that are prone to damage due to early frost. The disclosed crop protective compositions provide a delay bud break by up to approximately 10 to 14 days thereby reducing the likelihood of early frost damage. The composition is water resistant, providing a protective coating which also has advantageous physical properties that allow for the efficient application to crops (e.g., by spray application). Once applied, the compositions remain on plants and provides a barrier for protection against environmental stresses such as temperature drops or also for adsorption of nutritional or other components delivered by the composition for one or more weeks. Accordingly, the formulations and methods of the invention are particularly useful for preventing bud-break in commercial crop production settings.

The protective compositions of the invention include a mixture of a matrix forming agent, such as an alginate salt, a polysaccharide and a crosslinker component. In an embodiment the dehydrating agent or desiccant is a polysaccharide such as a sucrose, sorbitol, glucomannan, carrageenan, or fructose and the like and the crosslinker component is one or more of calcium chloride, a starch, and/or an acid.

Further components can include, a pigment, an alkalinity source, a cellulose, a surfactant, and/or silica particles.

In an embodiment, the protective composition further comprises additional active components such as acaricides, algicides, attractants, repellents, bactericides, fungicides, insecticides, nematicides, rodenticides, sterilants, viricides, growth regulators, plant strengthening agents, micronutrients, and macronutrients.

In an embodiment, the protective composition is a liquid with aa viscosity of less than about 2000 cp.

Provided herein is a method for reducing or delaying bud break in a crop and/or increasing cold hardiness of a crop. Without wishing to be bound by any theory, the compositions are also thought to act as an environmental insulator and slow the deacclimatization of cold hardy plants). The method comprises applying the protective composition as described herein to a crop. In an embodiment, the method further comprises applying a cross-linking agent to the crop. In an embodiment, the protective composition is applied by spraying. In an embodiment, the protective composition is applied during late winter and/or early spring and/or during ecodormancy. In an embodiment, the protective composition is applied in advance of the occurrence of bud break.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The drawings are presented for exemplary purposes and may not be to scale unless otherwise indicated.

FIG. 1A shows photographs of one chardonnay and one malbec grapevine treated with protective compositions labeled “N6” and “X1”, as compared to a control. These photographs were taken 14 days after treatment.

FIG. 1B shows photographs of one chardonnay and one malbec grapevine treated with protective compositions as compared to a control 20 days after treatment.

FIG. 1C shows photographs of one chardonnay and one malbec grapevine treated with protective compositions as compared to a control 27 days after treatment.

FIG. 2A is a graph of phenological observations of grapevines treated with protective compositions N6 and X1 compared to untreated control grapevines. The observations were made 14 days after treatment.

FIG. 2B is a graph of phenological observations of grapevines treated with protective compositions N6 and X1 compared to untreated control grapevines. The observations were made 20 days after treatment.

FIG. 2C is a graph of phenological observations of grapevines treated with protective compositions N6 and X1 compared to untreated control grapevines. The observations were made 27 days after treatment.

FIG. 3 is a graph of low temperature exotherm by evaluation date for grapevines treated with protective compositions and an untreated control. The data depicts the evolution of cold hardiness from September 22 to October 5. V2X1 was X1 applied two times, V1X1 X1 was applied one time.

FIG. 4 is a schematic diagram of an example of the molecular structure of a hydrogel network with different types of water.

FIG. 5 is a drawing of various common crosslinking mechanisms related to hydrogels.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION

Provided herein are compositions and methods that provide a sprayable liquid that forms a protective capsule around at least a portion of a crop and may remain on the crop for at least about 5 days and up to about 50 days. The protective composition provided herein can increase plant cold-hardiness by at least about 0.5° C., and up to about 10° C. or more and delay bud break. In a preferred embodiment, formulations of the invention have a negligible environmental footprint and are not toxic to plants, humans, or animals. The invention provides a protective composition capable of surviving variable weather conditions.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

The embodiments described herein are not limited to any particular composition, formulation, or method, which can vary and are understood by skilled artisans based on the present disclosure herein. It is further to be understood that all terminology used herein is for the purpose of describing particular embodiments only and is not intended to be limiting in any manner or scope.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation. The preferred materials and methods are described herein. In describing and claiming the embodiments of the present invention, the following terminology will be used in accordance with the definitions set out below.

As used in this specification and the appended claims, the singular forms “a,” “an,” and “the” can include plural referents unless the content clearly indicates otherwise. Further, all units, prefixes, and symbols may be denoted in its SI accepted form.

Numeric ranges recited within the specification are inclusive of the numbers within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g., 1 to 5 includes 1, 1.5, 2, 2.75, 3, 3.80, 4, and 5).

The term “percent,” “%,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The term “about,” as used herein, refers to variations in size, distance or any other types of measurements that can be resulted from inherent heterogeneous nature of the measured objects and imprecise nature of the measurements itself. The term “about” also encompasses variation in the numerical quantity that can occur, for example, through typical measuring or handling procedures in the real world; through inadvertent error in these procedures; through differences in the manufacture, source, or purity of the ingredients used to make the device or carry out the methods, and the like. Whether or not modified by the term “about”, the claims include equivalents to the quantities.

The methods and compositions may comprise, consist essentially of, or consist of the components and ingredients as well as other ingredients described herein. As used herein, “consisting essentially of” means that the methods and compositions may include additional steps, components, or ingredients, but only if the additional steps, components or ingredients do not materially alter the basic and novel characteristics of the claimed methods and compositions.

### Protective Compositions

The protective compositions as described herein comprise matrix forming agent such as an alginate. As used herein, “alginate” and “alginate salt” are used interchangeably and refer to all types of alginate salts, all types of alginates, and modifications, derivatives and/or combinations thereof and includes therein alginic acid. In an embodiment, alginate salt or alginate refers to combinations of alginates with differing molecular weights.

In an embodiment, the protective composition comprises an alginate having a molecular weight of from about 10 KDa to about 600 KDa. In an embodiment, the alginate has a molecular weight of from about 30 to about 100 KDa. In an embodiment, the alginate has a molecular weight of from about 30 to about 50 KDa. In an embodiment, the alginate has a molecular weight of from about 50 to about 200 KDa. In an embodiment, the alginate has a molecular weight of about 50 to about 150 KDa. In an embodiment, the alginate has a molecular weight of about 50 to about 100 KDa. In an embodiment, the alginate has a molecular weight of about 100 to about 200 KDa. In an embodiment, the alginate has a molecular weight of about 50 to about 150 KDa.

In an embodiment, the protective composition comprises an alginate in combination with alginic acid, depending on the pH of the composition. In an embodiment the pH of the composition is from about 5 to about 8.5.

In an embodiment, the protective composition comprises from about 1% to about 20% by weight alginate salt. In an embodiment, the composition comprises about 1% to about 15% by weight alginate salt. In an embodiment, the composition comprises about 1% to about 10% by weight alginate salt. In an embodiment, the composition comprises about 1% to about 5% by weight alginate salt. In an embodiment, the composition comprises about 2% to about 20% by weight alginate salt. In an embodiment, the composition comprises about 2% to about 15% by weight alginate salt. In an embodiment, the composition comprises about 2% to about 10% by weight alginate salt. In an embodiment, the composition comprises about 2% to about 5% by weight alginate salt. In an embodiment, the composition comprises about 3% to about 20% alginate salt. In an embodiment, the composition comprises about 3% to about 15% by weight alginate salt. In an embodiment, the composition comprises about 3% to about 10% by weight alginate salt.

In an embodiment, the protective composition comprises at least about 3% alginate salt.

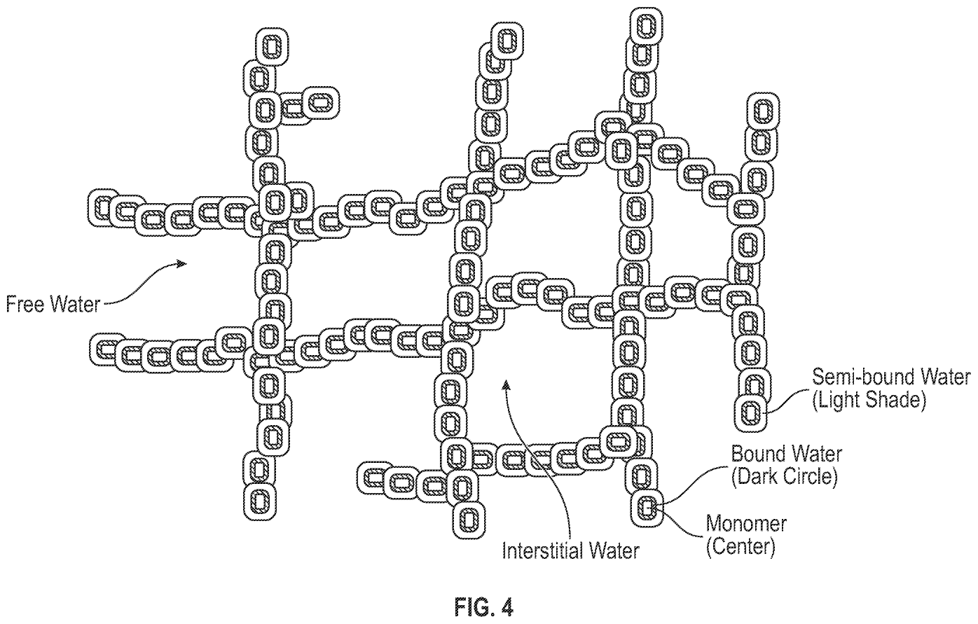

In an embodiment, the alginate component is a structural polysaccharide matrix forming agent as shown in FIG. 4, wherein the polymer networks in the hydrogel may absorb water at least about 10% and up to thousands of times their dry weight. This absorption can be tuned for the desired level of impending dehydration. In an embodiment, the polymer hydrogels comprise polyacrylic acid, polyethylene glycol, polyvinyl alcohol, non-mammalian non-gag/polysaccharides (e.g., pectin, chitosan and chitosan-based pH-dependent charged polyelectrolyte complexes, other alginate derivatives, dextran, cellulose, and pullulan), and synthetic polymers.

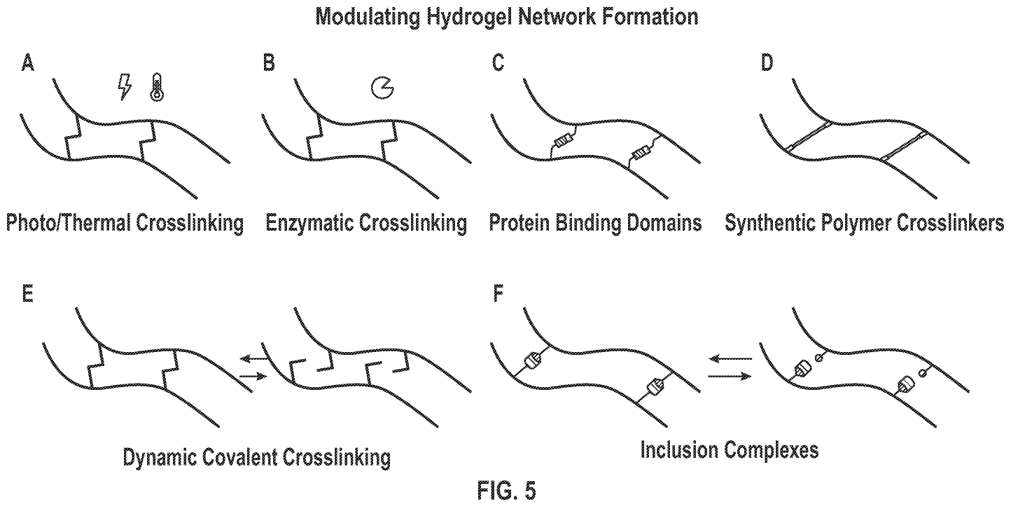

In an embodiment, the protective composition comprises a crosslinking component. In an embodiment, the protective composition utilizes a metal-ion modulated inclusion complex ionic crosslinking method as shown in FIG. 5. The crosslinking component is present in an amount of rom about 1 wt. % to about 20 wt. % preferable from about 1.5 wt. % to about 15 wt. % and most preferably from about 2 wt. % to about 10 wt. %.

In an embodiment, the protective composition further comprises a sugar.

As used herein, the term “sugar” includes monosaccharides, disaccharides, trisaccharides and dehydrating/polysaccharides. The term includes glucose, sucrose, fructose, and ribose, as well as deoxy sugars such as deoxyribose and the like. The term sugar also includes sugar alcohols, such as, for example, sorbitol. Saccharide derivatives can conveniently be prepared as described in International Patent Applications Publication Numbers WO 96/34005 and 97/03995, herein incorporated by reference in their entirety.

In an embodiment, the protective composition comprises at least one dehydrating/polysaccharide. In an embodiment, the protective composition comprises two or more dehydrating/polysaccharides. In an embodiment, the protective composition comprises a combination of several sugars. The dehydrating/polysaccharide serves as an osmotic source that dehydrates the plant meristem. The dehydrating polysaccharide(s) are present in an amount of from bout 30 Wt. % to about 80 wt. % preferably from about 35 wt. % to about 75 wt. % and more preferably from about 40 wt. % to about 70 wt. %.

In an embodiment, the dehydrating polysaccharide includes a glucomannan. In an embodiment, the glucomannan is a konjac glucomannan.

As used herein, “konjac glucomannan” refers to a class of water-soluble dehydrating/polysaccharides that are considered dietary fibers. It is a hemicellulose component in the cell walls of some plant species. Glucomannan is a food additive that may be used as an emulsifier and thickener. The chemical structure is according to Formula 1.

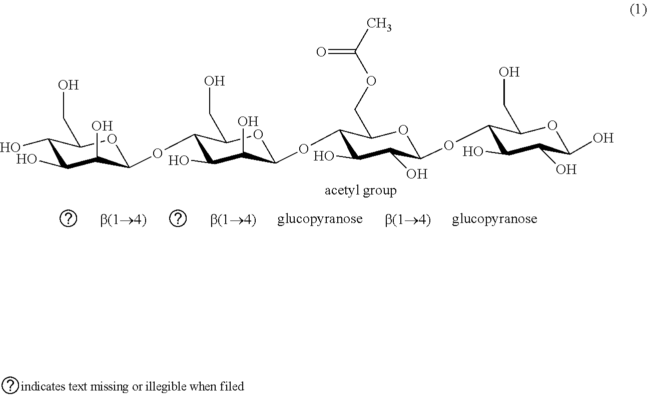

At specific concentrations relative to the water in the system, konjac glucomannan, among other things, forms dense structural networks that provides a mechanical toughness enhancement to the protective composition. Similar water-soluble network forming dehydrating/polysaccharides may be used to achieve similar functionalities within the protective composition.

In an embodiment, the dehydrating polysaccharide is a carrageenan.

As referred to herein, “carrageenan” refers to large, highly flexible molecules that form curling helical structures, giving them the ability to form a variety of different gels at room temperature. Carrageenans are high-molecular-weight dehydrating/polysaccharides and are mainly made up of alternating 3-linked b-D-galactopyranose (G-units) and 4-linked a-D-galactopyranose (D-units) or 4-linked 3,6-anhydro-a-D-galactopyranose (DA-units), forming the disaccharide repeating unit of carrageenans. Three main commercial classes of carrageenan include Kappa, Iota, and Lambda. Among other things, kappa-carrageenan forms strong, rigid gels in the presence of potassium ions, and reacts with dairy proteins. It is sourced mainly from Kappaphycus alvarezii. Among other things, iota-carrageenan forms soft gels in the presence of calcium ions. It is produced mainly from Eucheuma denticulatum. Lambda-carrageenan does not gel and is used to thicken dairy products. These properties may modulate the material and durability properties of the protective composition.

In an embodiment, the carrageenan is kappa-carrageenan. whose structure is according to

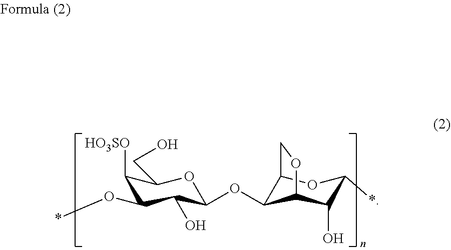

In an embodiment, the protective composition comprises a cellulose. In an embodiment, the protective composition comprises a microfibrillated cellulose.

As used herein, the term “microfibrillated cellulose” refers to any derivative of bulk cellulose that has been specially processed to reduce the average particle size down to the micron-scale with a fibrillar morphology. When combined with a sugar alcohol such as sorbitol, the dry microfibrillated cellulose will resuspend in water to reform the original expanded cellulose network. Such microfibrillated cellulose derivatives are available from Weidmann Electrical Technology AG, Neue Jonastrasse 60, 8640 Rapperswil SG, Switzerland.

In an embodiment, the protective composition comprises a solidifying agent. In an embodiment, the solidifying agent comprises gelatin.

As used herein, the term “gelatin” refers to a protein of uniform molecular constitution derived chiefly by the hydrolysis of collagen. Collagens include a class of albuminoids found abundantly in bones, skin, tendons, cartilage and similar animal tissues. Gelatin includes reagent grade gelatin supplied by Carolina Science Item #864660 but could be any low modulus solidifying agent that may operate in unison with the specific matrix arrangement of an alginate.

In an embodiment, the protective composition comprises an alkalinity source. In an embodiment, the alkalinity source comprises an alkali metal hydroxide, an alkali metal bicarbonate, and/or an alkali metal carbonate. Suitable alkali metal hydroxides, bicarbonates, and carbonates include, but are not limited to sodium carbonate, potassium carbonate, sodium bicarbonate, potassium bicarbonate, sodium hydroxide and potassium hydroxide. In an embodiment, the alkalinity source is an alkali metal bicarbonate. In an embodiment, the alkalinity source comprises sodium bicarbonate. The alkalinity source is provided in an amount sufficient to provide a protective composition with a pH of between about 7 and about 8.5.

As used herein, the term “cross-linking agent” includes any agent that can modify the physical properties of the composition of the invention so that it has physical properties to allow bud-break for a crop to be reduced or delayed. For example, the cross-linking agent can modify the mechanical properties of the composition so that it is capable of staying on the crop for an extended time, for example 1, 2, 3, 4 weeks, or more, while reducing or delaying bud-break. After cross-linking, the protective compositions of the invention have network polymers that are interconnected.

In an embodiment, the cross-linking agent comprises a metal ion or a salt thereof. In an embodiment, the cross-linking agent comprises a monovalent metal ion or a salt thereof. In an embodiment, the cross-linking agent comprises a divalent metal ion or a salt thereof. In an embodiment, the cross-linking agent comprises a calcium and/or magnesium ion or a salt thereof. In an embodiment, the cross-linking agent comprises calcium chloride and/or magnesium sulfate.

In an embodiment, the cross-linking agent comprises starch. In an embodiment, the cross-linking agent comprises corn starch, potato starch, casava starch, or combinations thereof. In an embodiment, the lightly hydrophobic characteristics of the starch may align on the outermost surface of protective composition to form a layer that is more impervious to the influx of water during rain events, prolonging the lifetime of the capsule by minimizing the amount of protective composition components leeching away from the composition. The components may play a role in film plasticity and toughness, and when leeched away the protective composition experiences a drop in mechanical properties and/or toughness.

In an embodiment, the cross-linking agent comprises an acid. The acid can include organic acids, inorganic acids, or a mixture thereof. Examples of acids include, for example, lactic acid, oxalic acid, uric acid, malic acid, tartaric acid, citric acid, formic acid, glycolic acid, gluconic acid, phosphoric acid, hydrochloric acid, sulfuric acid, nitric acid, acetic acid or peroxycarboxylic acids, and the like. A variety of acids can be formulated into the compositions to provide a desired pH. In an embodiment, the acid comprises citric acid. In an embodiment, the amount of acid is sufficient to provide a pH of between about 3.5 and about 7.

In an embodiment, the protective composition comprises a cross-linking agent. In an embodiment, the cross-linking agent is separate from the protective composition. In an embodiment, the cross-linking agent is mixed with one or more carriers such as water. In an embodiment, the cross-linking agent is in an aqueous solution. In an embodiment, the cross-linking agent is in a solution with a pH modified buffer solution. In an embodiment the pH modified buffer solution comprises citric acid.

In an embodiment, the protective composition further comprises a pigment and/or dye. In an embodiment, the pigment comprises mica, or titanium dioxide.

In an embodiment, the protective composition comprises silica particles, in an embodiment, the protective composition comprises fumed hydrophobic silica particles. Such particles may increase hygroscopic stability of the protective composition.

In an embodiment, the protective composition comprises a surfactant. Suitable surfactants can include anionic, cationic, amphoteric, zwitterionic, and/or nonionic surfactants. The surfactants mentioned below are only to be considered as examples; a large number of further surfactants which are conventionally used in the art of formulation and suitable according to the invention are described in the relevant literature.

Suitable non-ionic surfactants are, especially, polyglycol ether derivatives of aliphatic or cycloaliphatic alcohols, of saturated or unsaturated fatty acids or of alkyl phenols which may contain approximately 3 to approximately 30 glycol ether groups and approximately 8 to approximately 20 carbon atoms in the (cyclo)aliphatic hydrocarbon radical or approximately 6 to approximately 18 carbon atoms in the alkyl moiety of the alkyl phenols. Also suitable are water-soluble polyethylene oxide adducts with polypropylene glycol, ethylenediaminopolypropylene glycol or alkyl polypropylene glycol having 1 to approximately 10 carbon atoms in the alkyl chain and approximately 20 to approximately 250 ethylene glycol ether groups and approximately 10 to approximately 100 propylene glycol ether groups. Normally, the abovementioned compounds contain 1 to approximately 5 ethylene glycol units per propylene glycol unit. Examples which may be mentioned are nonylphenoxypolyethoxyethanol, castor oil polyglycol ether, polypropylene glycol/polyethylene oxide adducts, tributylphenoxypolyethoxyethanol, polyethylene glycol or octylphenoxypolyethoxyethanol. Also suitable are fatty acid esters of polyoxyethylene sorbitan, such as polyoxyethylene sorbitan trioleate. The cationic surfactants are, especially, quarternary ammonium salts which generally have at least one alkyl radical of approximately 8 to approximately 22 C atoms as substituents and as further substituents (unhalogenated or halogenated) lower alkyl or hydroxyalkyl or benzyl radicals. The salts are preferably in the form of halides, methylsulfates or ethylsulfates. Examples are stearyltrimethylammonium chloride and benzylbis(2-chloroethyl)ethyl-ammonium bromide. Examples of suitable anionic surfactants are water-soluble soaps or water-soluble synthetic surface-active compounds. Examples of suitable soaps are the alkali, alkaline earth or (unsubstituted or substituted) ammonium salts of fatty acids having approximately 10 to approximately 22 C atoms, such as the sodium or potassium salts of oleic or stearic acid, or of natural fatty acid mixtures which are obtainable for example from coconut or tall oil; mention must also be made of the fatty acid methyl taurates. However, synthetic surfactants are used more frequently, in particular fatty sulfonates, fatty sulfates, sulfonated benzimidazole derivatives or alkylaryl sulfonates. As a rule, the fatty sulfonates and fatty sulfates are present as alkali, alkaline earth or (substituted or unsubstituted) ammonium salts and they generally have an alkyl radical of approximately 8 to approximately 22 C atoms, alkyl also to be understood as including the alkyl moiety of acyl radicals; examples which may be mentioned are the sodium or calcium salts of lignosulfonic acid, of the dodecylsulfuric ester or of a fatty alcohol sulfate mixture prepared from natural fatty acids. This group also includes the salts of the sulfuric esters and sulfonic acids of fatty alcohol/ethylene oxide adducts. The sulfonated benzimidazole derivatives preferably contain 2 sulfonyl groups and a fatty acid radical of approximately 8 to approximately 22 C atoms. Examples of alkylarylsulfonates are the sodium, calcium or triethanolammonium salts of decylbenzenesulfonic acid, of dibutylnaphthalenesulfonic acid or of a naphthalenesulfonic acid/formaldehyde condensate. Also possible are, furthermore, suitable phosphates, such as salts of the phosphoric ester of a p-nonylphenol/(4-14)ethylene oxide adduct, or phospholipids. Further suitable phosphates are to tris-esters of phosphoric acid with aliphatic or aromatic alcohols and/or bis-esters of alkyl phosphonic acids with aliphatic or aromatic alcohols, which are a high-performance oil-type adjuvant. These tris-esters have been described, for example, in WO0147356, WO0056146, EP-A-0579052 or EP-A-1018299 or are commercially available under their chemical name. Preferred tris-esters of phosphoric acid for use in the compositions are tris-(2-ethylhexyl)phosphate, tris-n-octyl phosphate and tris-butoxyethyl phosphate, where tris-(2-ethylhexyl)phosphate is most preferred. Suitable bis-ester of alkyl phosphonic acids are bis-(2-ethylhexyl)-(2-ethylhexyl)-phosphonate, bis-(2-ethylhexyl)-(n-octyl)-phosphonate, dibutyl-butyl phosphonate and bis(2-ethylhexyl)-tripropylene-phosphonate, where bis-(2-ethylhexyl)-(n-octyl)-phosphonate is particularly preferred.

### Further Active Ingredients

The composition can comprise additional active ingredients. Other active ingredients can include acaricides, algicides, attractants, repellents, bactericides, fungicides, insecticides, nematicides, rodenticides, sterilants, viricides, growth regulators, plant strengthening agents, micronutrients, and/or macronutrients. The present application, however, is not limited to these active ingredients listed herein, but also includes more modern active ingredients not yet cited. Examples of active fungicide active ingredients which are combined in crop protection composition products alone or in a mixture with other active ingredients are: azoxystrobin, benalaxyl, benomyl, bitertanol, borax, bromocuonazole, sec-butylamine, captafol, captan, calcium polysulphide, carbendazim, quinomethionate, chlorothalonil, chlozolinate, copper and its derivatives, copper sulphate, cyprodinil, cyproconazole, dichlofluanid, dichlorophen, diclomezine, dicloran, diethofencarb, difenoconazole, dimethomorph, diniconazole, dithianon, epoxiconazole, famoxadone, fenarimol, fenbuconazole, fenfuram, fenhexamid, fenpiclonil, fenpropidin, fenpropimorph, fentin, fluazinam, fludioxonil, fluoroimide, fluquinconazole, flusulfamide, flutolanil, folpet, fosetyl, furalaxyl, guazatine, hexachlorobenzene, hexaconazole, hydroxyquinoline sulphate, imibenconazole, iminoctadine, ipconazole, iprodione, kasugamycin, kresoxim-methyl, mancozeb, maneb, mefenoxam, mepanipyrim, mepronil, mercury chloride, metam, metalaxyl, metconazole, metiram, nabam, nickel bis(dimethyldithiocarbamate), nuarimol, oxadixil, oxine-copper, oxolinic acid, penconazole, pencycuron, picoxystrobin, phthalide, polyoxin B, prochloraz, procymidone, propamocarb, propiconazole, propineb, pyrifenox, pyraclostrobin, pyroquilon, quintozene, spiroxamine, sulphur, tebuconazole, tecloftalam, tecnazene, thiabendazole, thifluzamide, thiophanate-methyl, thiram, tolclofosmethyl, tolylfluanid, triadimefon, triadimenol, triazoxide, trifloxystrobin, triforin, triticonazole, vinclozolin, zineb, ziram, salts thereof and mixtures thereof. In another embodiment of the invention, the fungicides are strobilurin and related fungicides classes of chemistries which include azoxystrobin, enestrobin, picoxystrobin, pyraclostrobin, kresoxim-methyl, trifloxystrobin, dimoxystrobin, metominostrobin, orysastrobin, famoxadone, fluoxastrobin, fenamidone, pyribencarb, cyazofamid, amisulbrom, and mixtures thereof, these fungicides and mixtures thereof are used in cereals (wheat, barley, rye, triticale, rice) to control crop diseases.

Examples of active ingredients (alone or in mixtures) of insecticides are: abamectin, acephate, acetamiprid, acrinathrin, amitraz, azadirachtin, azamethiphos, azinphos-methyl, azocyclotin, bensultap, bifenthrin, bromopropylate, buprofezin, butoxycarboxim, cartap, chlorfenapyr, chlorfenson, chlorfluazuron, clofentezine, coumaphos, cyfluthrin, beta-cyfluthrin, lambda-cyhalothrin, cypermethrin, alpha-cypermethrin, theta-cypermethrin, cyromazine, DDT, deltamethrin, diafenthiuron, dicofol, dicrotophos, difenthiuron, diflubenzuron, dimethoate, emamectin benzoate, endosulfan, esfenvalerate, etoxazole, fenazaquin, fenbutatin oxide, fenoxycarb, fenpyroximate, fipronil, fluazuron, flucycloxuron, flufenoxuron, tau-fluvalinate, formetanate, furathiocarb, halofenozide, gamma-HCH, hexaflumuron, hexythiazox, hydramethylnon, hydrogen cyanide, imidacloprid, lufenuron, methamidophos, methidathion, methiocarb, methomyl, methoxychlor, mevinphos, milbemectin, mineral oils, monocrotophos, nicotin, nitenpyram, novaluron, omethoate, organophosphorus compounds, oxamyl, oxydemeton-methyl, pentachlorophenol, phosphamidon, pymetrozin, permethrin, profenofos, pyridaben, rapeseed oil, resmethrin, rotenone, spinosad, sulfluramid, tebufenozide, tebufenpyrad, tebupirimfos, teflubenzuron, tetrachlorvinphos, tetradifon, tetramethrin, thiamethoxam, thiocyclam, thiodicarb, tralomethrin, trichlorfon, friflumuron, trimethacarb, vamidothion, and salts thereof and mixtures thereof.

Examples of active ingredients in products from the group of growth regulators are: 6-benzylaminopurine, chlormequat, chlorphonium, cimectacarb, clofencet, cloxyfonac, cyanamide, cyclanilide, daminozide, dikegulac, ethephon, flumetralin, forchlorfenuron, gibberilic acid, inabenfide, indolylbutyronic acid, 2-(1-naphthyl)acetamide, mepiquat, paclobutrazol, N-phenyl-phthalaminic acid, thidiazuron, trinexapac-ethyluniconzole, and salts thereof and mixtures thereof.

Plant nutrients and plant micronutrients which are applied in liquid form in liquid preparation in highly diverse forms alone or in combination with other nutrients or in combination with crop protection compositions are for example nitrogen (in nitrogen fertilizers), phosphate, potassium, calcium, magnesium, manganese, boron, copper, iron (in iron fertilizers), selenium, cobalt, zinc, which can also be present, for example, as oxides, sulphates or carbonates, and others which are known under the name micronutrients.

In an embodiment, the protective composition is formulated by simply admixing the components together. In certain embodiments thickeners or other agents such as gelatin must first be dissolved in water before mixing. The protective composition is traditionally in the form of an aqueous composition, for example a liquid, gel, and/or paste. In an embodiment, the protective composition is in solid form, for example a powder or granule, and is then combined with water prior to use. In an embodiment, the protective composition is a gel with a viscosity from about 500 cp to about 2000 cp. In an embodiment, the protective composition has a viscosity less than 2000 cp.

In an embodiment, the protective compositions described herein delay dormant bud break through physiological and mechanical effects. In an embodiment, the protective composition acts through targeted dehydration of bud and/or cane tissues, redistributing water among them and restricting gases that participate in plant metabolic processes. In an embodiment, the protective composition provides a physical constraint to a bud that reinforces slow development by low conversion of meristematic cells. In an embodiment, the protective composition induces differential genes and transcription factor expression. In an embodiment, the composition induces stress response genes such as, but not limited to, heat shock proteins, #HRU1, and ZPR2 family microproteins. In an embodiment, the protective composition induces proteolysis of transcriptional regulators that control different aspects of meristematic growth development. In an embodiment, the protective composition maintains the fluidity and structure of cellular membranes of bud and/or cane tissue. In an embodiment, the protective composition affects chromatin dynamics in a bud, including those that control conversion of meristematic cell to flowers. In an embodiment, the protective composition acts on plant hormone transporters that induce redistribution of plant hormones in bud meristems. In an embodiment, the protective composition modifies environmental and metabolic cues that affect meristem development by reducing sugar stimuli to generate new organs. In an embodiment, the protective composition affects the redox regulated processes involved in multilayered interactions that control plant growth and development. In an embodiment, the protective composition blocks UV and other wave lengths needed as signals to start meristem development as well as enhance capsule longevity.

In an embodiment, the compositions result in about 75% dehydration of the apical meristem. In an embodiment, the protective compositions described herein restrict water to the apical meristem to slow plant cellular division and growth.

The compositions and methods described herein increase plant cold-hardiness. Warmer temperatures occurring in early spring accelerate the processes of loss of cold hardiness. The compositions and methods described herein allow buds to maintain a natural cold hardiness for extended periods. In late winter/early spring, especially as climate change becomes more evident, periods of abnormally high temperature during the onset of winter and/or early spring could trigger a relatively fast bud deacclimitization making crops more vulnerable to frost damage and “silent” frost damage. As used herein “silent” frost damage includes frost injuries that are not initially apparent but become evident later in the season. The compositions and methods described herein can enhance freeze resistance by decreasing the killing point of tender meristems up to 10 degrees or more.

The compositions and methods described herein reduce and/or eliminate the need for double pruning of crops, including grapevines, during the growing season. In an embodiment, the compositions and methods described herein eliminate and/or reduce the need for late pruning which is a technique used by many growers to increase bud break delay.

The compositions and methods described herein slow the development of shoots to increase the window of opportunity to mechanize shoot thinning, for example in grape crops. Mechanized vineyard operations are increasingly being viewed as a viable means of reducing production costs and labor requirements while maintaining or increasing product quality. Mechanized shoot thinning is most effective with shoots that are about six inches long. If done late, shoots grow too much and the application of chemical agents is ineffective, therefore growers wishing to mechanize shoot thinning must purchase and store many machines to remove shoots from an entire vineyard when they reach an appropriate length. Delaying bud break allows reduction in the number of machines needed.

In an embodiment, the protective composition is not toxic to plants, humans, and/or animals. In an embodiment, the protective composition comprises non-hormonal compounds without phytotoxic effects or toxicity to humans. In an embodiment, the protective composition is entirely organic and suitable for use in organic agricultural settings.

### Method of Use

The composition may be applied as a gel or spray depending on the time of application and the desired persistence of the material on the plant. In some embodiments a cross linker may be used to thicken the composition. One may want to apply the gel in thin layers e.g.: spray one thin layer then apply the cross linker, then wait until the excess of crosslinker evaporates and then repeat up to 3 or four times. In this way we can increase toughness and work with less dense gel to improve spread ability of the gel.

The protective compositions described herein are applied to a crop. As used herein, “crop” refers to a cultivated plant grown for later consumption. As used herein, crop refers to any part of the plant, or the entirety of the plant, for example an entire grape vine or the buds of a grapevine. “Crop” includes all varieties and species of vitis including all the European Vitis vinifera and American geneses such as Vitis arizonica, Vitis vulpina, Vitis californica, and Vitis labrusca, Vitis riparia, Vitis aestivalis, Vitis rotundifolia, Vitis rupestris, Vitis amurensis, native to the Asian continent, including parts of Siberia and China. The term also includes all species of fruit species that go through dormancy cycles, including but not limited to citrus, peaches, cherries, plums, apricots, almonds, walnuts, apples, pears, blueberries, blackberries, and raspberries, specialty crops such as tomatoes, beans, peas, etc., tea species and varieties, ornamental crops, decorative species, flowers, herbaceous plants, gardening species, etc.

The protective compositions described herein can be applied by any method, for example by spraying, sprinkling, dipping, painting, broadcasting and the like. The protective composition described herein can be applied mechanically, for example with a sprayer, a tractor, and the like, or manually. In an embodiment, the protective compositions are applied by spraying. In an embodiment, the protective composition is applied with an airless high-pressure sprayer. In an embodiment, a targeted spray system based on electrostatic spraying technology is used wherein adequate pressure supports the flow of the protective composition while simultaneously avoiding clogging.

In an embodiment, the protective composition is applied to the entire plant or crop. In an embodiment, the protective composition is applied to at least a portion of a crop. In an embodiment, the protective composition is applied to at least the buds of a crop. In an embodiment, the protective composition is applied to spurs and cordons on dormant grapevines.

In an embodiment, a cross-linking agent is applied separately from the protective composition by any of the methods described herein. In an embodiment, the cross-linking agent is applied as a component of the protective composition. In an embodiment, the cross-linking agent is applied before the protective composition. In an embodiment, the cross-liking agent is applied after protective composition. In an embodiment, the cross-linking agent is applied simultaneously with the protective composition. In an embodiment, the cross-linking agent is applied within one minute of the protective composition. In an embodiment, the cross-linking agent is applied within seconds of the protective composition. In an embodiment the cross-linking agent is applied within minutes of protective composition. In an embodiment, the cross-linking agent is applied to a crop from about one minute to about 12 hours after the protective composition. In an embodiment, the cross-linking agent is applied to a crop from about one minute to about six hours after the protective composition. In an embodiment, the cross-linking agent is applied to a crop from about one minute to about two hours after the protective composition.

In an embodiment, the cross-linking agent is applied more than once. The cross-linking agent may be applied hot, warm, or cold depending on the desired crosslinking reaction. The warmer crosslinker increases the diffusion of the crosslinking moieties within the sodium alginate matrix, resulting in a more mechanically robust final film product. In an embodiment the cross-linking agent is applied twice. In an embodiment, the cross-linking agent is applied both before and after the protective composition. In an embodiment, the cross-linking agent is applied twice after applying the protective composition.

Described herein is a method for reducing or delaying bud break in a crop. As used herein, the term “bud break” includes all stages conducive to bud activation and development including, but not limited to, bud swell, first scales start opening and show a wooly appearance, and the tip of the first leaf starting to be evident. Full bud break comprises when a first leaf appears. Bud break, under normal conditions, can take up to a week to have 100% of buds with a first leaf. However, when a frost happens close to bud break the process can take to 2 weeks or more depending on the intensity of the frost and the variety of crop. Bud break can be measured by visual estimation of the stages, for example, every 2 days, and more frequent if air temperature conditions are conducive to fast shoot development.

In an embodiment, the method comprises applying any one of the protective compositions described herein to any portion of a crop. In an embodiment, the crop is a fruit crop. In an embodiment, the crop comprises grapes, peaches, cherries, plums, apricots, almonds, walnuts, apples, pears, blueberries, raspberries, citrus, tomatoes, beans, peas, tea species, ornamental crops, decorative species, flowers, herbaceous plants, gardening species

In an embodiment, the protective composition and/or the cross-linking agent is applied to a crop at least one times over a period of one to three weeks. In an embodiment, the protective composition and/or the cross-linking agent is applied to a crop twice over a period of one to three weeks.

In an embodiment, from about 1% to about 99% of the protective composition remains on the crop for at least about 1 day, at least about 5 days, at least 10 days, at least about 21 days, at least about 28 days, at least about 35 days, or at least about 50 days. In an embodiment, at least about 50% of the protective composition remains on the crop for at least about 1 day, at least about 5 days, at least 10 days, at least about 21 days, at least about 28 days, at least about 35 days, or at least about 50 days. In an embodiment, at least about 75% of the protective composition remains on the crop for at least about 1 day, at least about 5 days, at least 10 days, at least about 21 days, at least about 28 days, at least about 35 days, or at least about 50 days. In an embodiment, at least about 90% of the protective composition remains on the crop for at least about 1 day, at least about 5 days, at least 10 days, at least about 21 days, at least about 28 days, at least about 35 days, or at least about 50 days. In an embodiment, at least about 95% of the protective composition remains on the crop for at least about 1 day, at least about 5 days, at least 10 days, at least about 21 days, at least about 28 days, at least about 35 days, or at least about 50 days.

In an embodiment, the protective composition creates a protective around dormant crops. The layer may provide protection against any of a number of threats. thermal, ultraviolet light, fungal/mildew (biological protection), or mechanical protection by means of a protective.

The effectiveness of the compositions and methods described herein can be tested through the following assays: gas permeability, barrier capabilities, mechanical properties, water-cycling durability, thermal stability, conductivity, osmolarity, toughness, and microstructure and lamellar orientation.

In an embodiment, the protective composition is applied during late winter and/or early spring. In an embodiment, the protective composition is applied wherein the environmental condition promote the deacclimatization of a bud's meristems and cane tissues (loss of cold hardiness). In an embodiment, the protective composition is applied wherein the physiological activation of a bud meristem is conducive to the bud sprouting processes. In an embodiment, the protective composition is applied during ecodormancy, wherein buds are no longer dormant, but growth is suppressed because environmental conditions are not optimal. In an embodiment, the protective composition is applied after the satisfaction of chilling requirements that indicate the physiological activity status of the grape vines.

In an embodiment, the protective composition is applied about 4 weeks in advance of the occurrence of bud break.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims

### Example 1

A protective composition according to the invention comprising alginate and at least one dehydrating/polysaccharide was applied to grape varieties to assess cold hardiness and bud break delay. The protective composition was applied such that the entire surface of the grape plant was completely covered with a layer of the composition of 2 to 3 millimeters. A cross-linking solution comprising calcium chloride was applied immediately thereafter. If the protective composition began to drip, the cross-linking solution was applied a second time.

The protective composition showed an average of 5 to at least 14 days of bud break delay. The results depended upon grape cultivar, physiological status of the grapevine, and the number of days prior to bud break the composition is applied.

Application of the protective composition increased the grapevine bud's cold hardiness by delaying the deacclimatization of the vines (i.e., lowering the killing temperature), which in turn makes ecodormant buds more resistant to cold injuries. Cold hardiness of treated buds was 3-6° C. higher than controls.

The protective composition reduced losses for silent frost damage of unbroken buds by increasing the yield an average of 32% compared to control.

### Example 2

Two protective compositions according to the invention were used in laboratory evaluations. Composition N6 was formulated according to the invention and comprises alginate as the matrix component, carrageenan, sucrose and fructose as the dehydrating/polysaccharide with KCl as the cross-linker. Composition X1 was formulated according to the invention and comprises alginate and cellulose as the matrix forming agents, glucomannan, sucrose, fructose as the dehydrating/polysaccharide, and cellulose as the cross-linker. The compositions were applied to two grape varieties, chardonnay and malbec, and compared to a control that was without treatment.

The phenological observations were performed by an independent third-party lab between September 22 and October 5. September 22 was 14 days post-application, and 80% of buds in the control grapevines were at initial to complete bud swell stage while 20% were already in wooly bud stage. Conversely, buds treated with X1 and N6 were at 60% and 75% winter bud stage, respectively, with the remainder in initial bud swell stage. By September 28, the control samples had reached 40% bud break while the 20-25% most phenologically advanced treated buds were in wooly stage, with all others still in some bud swell stage. By October 5, 20% of grapevine buds treated with X1 had reached bud break and 0% of grapevine buds treated with N6 had achieved bud break, and only 10% had progressed to wooly stage.

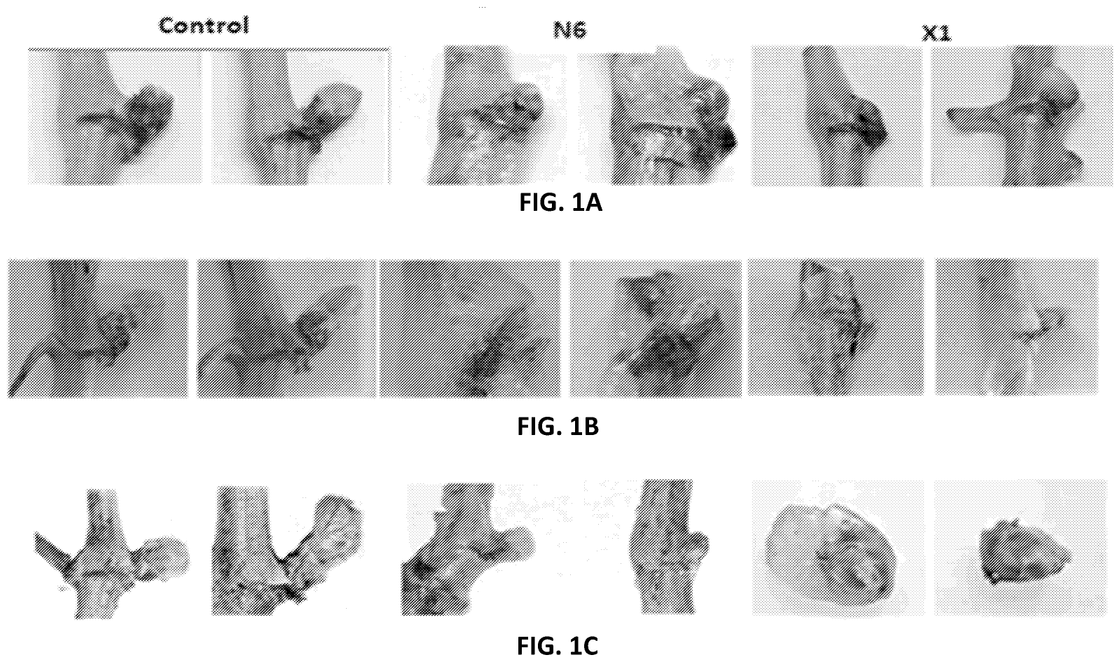

This is shown in FIG. 1A, FIG. 1B, and FIG. 1C. FIG. 1A depicts photographs of two control grapevines (one Chardonnay and one Malbec), two grapevines treated with N6, and two grapevines treated with X1, on September 22, 14 days post-application. FIG. 1B depicts photographs of the grapevines on September 28, and FIG. 1C shows photographs of the grapevines on October 5. These figures show that the different treatments led to different bud phenology. Compared with the control, grapevines treated with formula X1 delayed bud break at least 10 days, while grapevines treated with N6 had a delay in bud break of at least 14 days. For the Chardonnay variety, both N6 and X1 provided a significant delay in bud break, while for the Malbec variety, N6 performed the best by delaying budbreak during the entire observation period. In both formulas, the capsules maintained structural integrity until bud break, confirming that the capsule's integrity is critical for the efficacy of the protective technology.

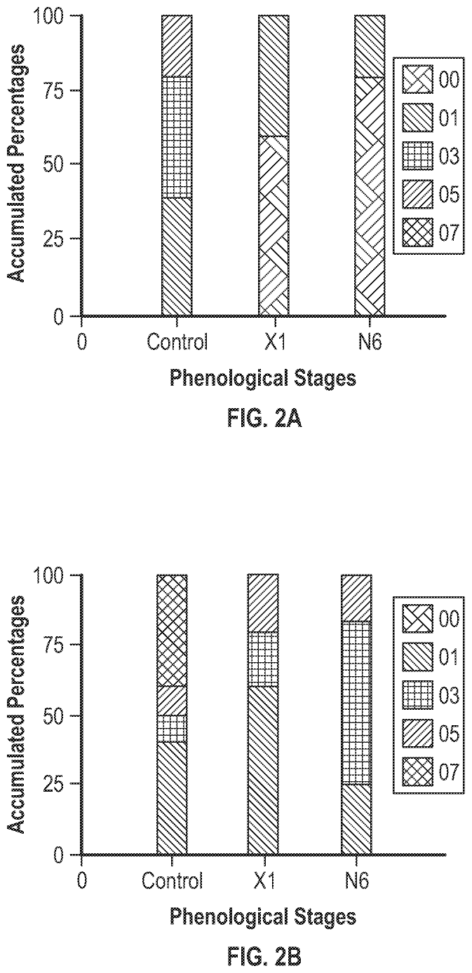

The grapevines were subjected to cold days and frost events between October 1 and October 5 which affected the natural trajectory of bud break. On October 4, the grapevines were exposed to a freeze event of −2.6° C. Roughly 15% of primary buds in control plots were killed, with secondary buds reportedly breaking about two weeks later. In the treated grapevines, primary buds were not killed. This reduced the differences in bud break rates in the subsequent sampling dates and increased the variability within replicates. One consequence of this frost event was a large variability of budbreak and shoot growth, which can be observed in FIGS. 2A, 2B, and 2C. These figures depict graphs of the evolution of phenological observations from September 22 to October 5. FIG. 2A is a graph of the phenological stages on September 22; FIG. 2B is a graph of the phenological observations on September 28; and FIG. 2C is a graph of the phenological observations on October 5. “00” indicates a dormant, winter bud; “01” indicates an initial bud swell, “03” indicates a full bud swell; “05” indicates a wooly bud; and “07” indicates a green tip, indicating bud break. The percentage of budbreak was on average 10-20% lower in the treated buds than in control during October, with treated plots catching up by November 2. The average budbreak delay in treated buds with the best formulas was 10 days during the high freeze damage risk days in early October. A second application of the X1 formula increased the delay by about one week.

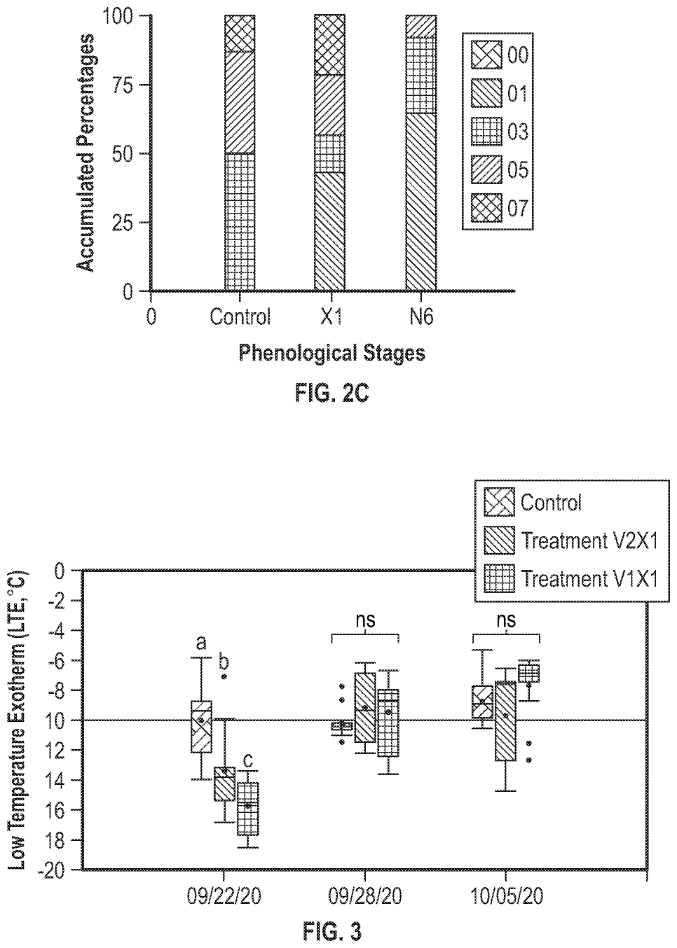

Buds from control and the two treatments, were collected on the three sampling dates September 22, September 28, and October 5 and assessed for cold hardiness using differential thermal analysis (“DTA”), based on low temperature exotherms. Weather conditions during the days prior to the first sampling date were very conducive to deacclimitization due to abnormally warm temperatures for the season and capsule durability of the protective composition was maintained throughout. The cold resistance in spurs treated with both formulations were higher than the controls, as shown in FIG. 3. FIG. 3 is a graph of low temperature exotherm for the treated buds and a control, by sample date. In this graph, composition N6 is labeled “V2X1” and composition X1 is labeled “V1X1.” The difference in resistance between the control and X1 is 5.72° C., while the difference in resistance between the control and N6 is 8.12° C. Furthermore, spurs treated with N6 showed about 2.4° C. more resistance compared to treatment X1. These results confirm that the bud break delay technology is most effective reducing the rate of deacclimitization and thus the vulnerability of buds to freezing injuries.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A protective composition comprising:
an alginate salt;
at least one dehydrating/polysaccharide compound; and
one or more of a solidifying agent, a glucomannan, and a carrageenan.

2. The protective composition of claim 1, wherein the protective composition comprises two or more dehydrating/polysaccharides.

3. The protective composition of any one of claims 1-2, wherein the protective composition comprises a solidifying agent.

4. The protective composition of claim 3, wherein the solidifying agent comprises a gelatin.

5. The protective composition of any one of claims 1-4, wherein the protective composition comprises a glucomannan.

6. The protective composition of claim 5, wherein the glucomannan is konjac glucomannan.

7. The protective composition of any one of claims 1-6, wherein the protective composition comprises a carrageenan.

8. The protective composition of any claim 7, wherein the carrageenan is kappa-carrageenan.

9. The protective composition of any one of claims 1-8, wherein the dehydrating/polysaccharide comprises sorbitol.

10. The protective composition of any one of claims 1-9, further comprising a cross-linking agent.

11. The protective composition of claim 10, wherein the cross-linking agent comprises a monovalent metal ion or salt thereof.

12. The protective composition of claim 10, wherein the cross-linking agent comprises a divalent metal ion or salt thereof.

13. The protective composition of claim 10, wherein the cross-linking agent comprises a calcium or magnesium ion or salt thereof.

14. The protective composition of claim 13, wherein the cross-linking agent comprises calcium chloride or magnesium sulfate.

15. The protective composition of any one of claims 10-14, wherein the cross-linking agent comprises a starch.

16. The protective composition of any one of claims 10-15, wherein the cross-linking agent comprises an acid.

17. The protective composition of claim 16, wherein the acid comprises citric acid.

18. The protective composition of any one of claims 1-17, wherein the composition comprises 1-20% alginate salt.

19. The protective composition of any one of claims 1-18, wherein the composition further comprises a pigment and/or dye.

20. The protective composition of claim 19, wherein the pigment comprises titanium dioxide.

21. The protective composition of any one of claims 1-20, wherein the composition further comprises an alkalinity source.

22. The protective composition of claim 21, wherein the alkalinity source comprises sodium bicarbonate.

23. The protective composition of any one of claims 1-22, wherein the composition comprises a polymer hydrogel matrix.

24. The protective composition of any one of claims 1-23, wherein the composition comprises a cellulose.

25. The protective composition of claim 24, wherein the cellulose comprises microfibrillated cellulose.

26. The protective composition of any one of claims 1-25, wherein the protective composition is non-toxic to plants, animals, and humans.

27. The protective composition of any one of claims 1-26, wherein the protective composition further comprises silica particles.

28. The protective composition of any one of claims 1-27, wherein the protective composition further comprises a surfactant.

29. The protective composition of any one of claims 1-28, wherein the protective composition is a liquid and has a viscosity of less than about 2000 cp.

30. A method for reducing or delaying bud break in a crop and/or increasing cold hardiness of a crop, the method comprising:
applying a composition according to any one of claims 1-29 to the crop.

31. The method of claim 30, wherein the crop is a fruit crop.

32. The method of any one of claims 30-31, wherein the crop is grapes.

33. The method of claim 32, wherein the crop comprises a European Vitis vinifera or an American geneses.

34. The method of any one of claims 30-33, wherein the crop is grapes, peaches, cherries, plums, apricots, almonds, walnuts, apples, pears, blueberries, raspberries, citrus, tomatoes, beans, and/or peas.

35. The method of any one of claims 30-35, further comprising applying a cross-linking agent to the crop.

36. The method of claim 35, wherein the cross-linking agent is applied to the crop before the protective composition.

37. The method of claim 35, wherein the cross-linking agent is applied to the crop after the protective composition.

38. The method of claim 35, wherein the cross-linking agent is applied to the crop simultaneously with the protective composition.

39. The method of any one of claims 30-38, wherein the protective composition is applied to the crop twice over a period of one to three weeks.

40. The method of any one of claims 30-39, wherein at least about 50% of the protective composition, at least about 75% of the protective composition, or at least 90% of the protective composition remains on the crop for at least about 10 days.

41. The method of any one of claims 30-40, wherein at least about 50% of the protective composition, at least about 75% of the protective composition, or at least 90% of the protective composition remains on the crop for at least about 21 days.

42. The method of any one of claims 30-41, wherein at least about 50% of the protective composition, at least about 75% of the protective composition, or at least 90% of the protective composition remains on the crop for at least about 28 days.

43. The method of any one of claims 30-42, wherein at least about 50% of the protective composition, at least about 75% of the protective composition, or at least 90% of the protective composition remains on the crop for at least about 35 days.

44. The method of any one of claims 30-43, wherein at least about 50% of the protective composition, at least about 75% of the protective composition, or at least 90% of the protective composition remains on the crop for at least about 50 days.

45. The method of any one of claims 30-44, wherein the protective composition is applied by spraying.

46. The method of any one of claims 30-45, wherein the protective composition is applied in combination with fungicides and/or insecticides.

47. The method of any one of claims 30-46, wherein the protective composition is applied during late winter and/or early spring.

48. The method of any one of claims 30-47, wherein the protective composition is applied during ecodormancy.

49. The method of any one of claims 30-48, wherein the protective composition is applied about 4 weeks in advance of the occurrence of bud break.
